(19) United States
(12) Patent Application Publication
(10) Pub. No.: US 2019/0105871 A1
(43) Pub. Date: Apr. 11, 2019

(54) PROCESS FOR CREATING PLYFIBER SHEETS FOR CONSTRUCTION APPLICATIONS

(71) Applicant: Neauvotec, LLC, Auburn Hills, MI (US)

(72) Inventor: Miguel A. Linares, Bloomfield Hills, MI (US)

(73) Assignee: Neauvotec, LLC, Auburn Hills, MI (US)

(21) Appl. No.: 16/152,838

(22) Filed: Oct. 5, 2018

Related U.S. Application Data
(60) Provisional application No. 62/569,044, filed on Oct. 6, 2017.

(51) Int. Cl. B32B 7/00; B32B 7/12; B32B 21/10; B32B 37/18; B32B 37/12

(52) U.S. Cl. CPC B32B 7/005; B32B 7/12; B32B 21/10; B32B 2553/00; B32B 37/1207; B32B 2262/065; B32B 2479/00; B32B 37/18

(57) ABSTRACT

The present invention discloses a line process for creating a multi-ply fiber sheet, which includes each of the steps of providing a non-activated adhesive fluid bath, immersing within the fluid bath a series of ply fiber sheets in order to coat a heat activated adhesive, stacking the sheets according to a desired plurality, and activating the adhesive within the stack to bond the sheets together. Other steps include pre cleaning and treating the sheets prior to immersing, as well as stacking individual ply fiber sheets in either of alternating lengthwise and crosswise seam extending fashion or in alternating and opposing diagonal extending fashion. The step of activating the adhesive can further include placing the stack into a heat press, as well as the use of any of liquid, light, steam, or heat.

### CROSS REFERENCE TO RELATED APPLICATIONS

The present application claims priority from U.S. Ser. No. 62/569,044 filed Oct. 6, 2018, the contents of which are hereby incorporated by reference.

### FIELD OF THE INVENTION

The present invention relates generally to processes for producing multi-ply construction board articles. More particularly, the present invention teaches a process for creating a ply-fiber particle board which substitutes the thin layers of wood utilized in similar plywood forming processes with pressed mats of fibers constructed of and natural occurring waste or bi-products not limited to bamboo, sugar cane, corn, palms, coconut, etc.

### BACKGROUND OF THE RELEVANT ART

The prior art teaches a variety of forming processes for creating such as a composite board material. Other processes and assemblies are known for producing such boards which can include the use of natural materials. An example of this is depicted in WO 96/09921 which teaches a structural board formed by strips of bamboo which are joined side-by-side to form a sheet, which is then dried and impregnated with a resin. The sheets are then placed together face to face to form the boards with alternative sheets having the strips lengths at right angles to one another. The boards are then hot pressed to cure the resin and to create a structural board having strength and moisture resistant properties.

### SUMMARY OF THE PRESENT INVENTION

The present invention discloses a line process for creating a multi-ply fiber sheet, which includes each of the steps of providing a non-activated adhesive fluid bath, immersing within the fluid bath a series of ply fiber sheets in order to coat a heat activated adhesive, stacking the sheets according to a desired plurality, and activating the adhesive within the stack to bond the sheets together.

Other steps include pre cleaning and treating the sheets prior to immersing, as well as stacking individual ply fiber sheets in either of alternating lengthwise and crosswise seam extending fashion or in alternating and opposing diagonal extending fashion. The step of activating the adhesive can further include placing the stack into a heat press, as well as the use of any of liquid, light, steam, or heat.

Other steps include precutting the sheets to a specified oversized dimension prior to subsequently stacking, gluing and pressing together to form a thick solid finished sheet which is cut to size. Additional steps include producing the sheets within a single setup, flipping alternate sheets to create diagonally opposing grains and applying natural wood layers around the stacked sheets.

Other steps further include forming the ply fiber sheets from any of natural occurring or organic waste or byproduct integrating one or more components not limited to bamboo, sugar cane stalks, corn stalks, palms, or coconut and which can be utilized to produce and of sheet, pallet, furniture or cabinetry articles.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a first variant of a line process for creating a multi-ply fiber sheet including the provision of a non-activated adhesive fluid bath within which the previously prepared fiber sheets, these previously having being cleaned and treated for pests or moisture, are immersed for coating with the adhesive and subsequently formed into sheets, trimmed, stacked and placed into a heat press in order to activate the adhesive in order to bond together;

FIG. 2 is a similar illustration of an array of fiber sheets, such being oriented in crosswise (lengthwise versus crosswise) seam extending directions, post or cylinder rolled or pressed into thin sheets and in order to concurrently activate the liquid adhesive via any of liquid, light, steam, heat or the like, the sheets being precut in a specified oversized dimension and subsequently stacked, glued and pressed together to form a thick solid finished sheet which is cut to size;

FIG. 3 is a related variant of a diagonal orientation of ply-fiber sheets, such eliminating the necessity of dual setups for lengthwise and widthwise fiber sheets and instead including the diagonal fiber sheets being produced in the same setup, with the alternating sheet flipped to create a diagonally opposing grain;

FIG. 4 is a stacked illustration of multi-ply fiber sheets with natural wood layers added as outer layers to the final product in order to exhibit a natural appearance;

FIGS. 5-7 are illustrations of exemplary articles which are produced according to the process for forming a multi ply-fiber article, such including by non-limiting examples each of pallets, furniture and cabinetry;

FIG. 8 is an illustration of a structural panel produced according to a further embodiment of the present invention which incorporates overlapping layers of any of bamboo leaves, burlap, palm, tree fiber, banana leaves or the like; and

FIG. 9 is an illustration of an alternate version of structural panel in which the individually joined sections of organic material including in the listing of FIG. 8 also include any of pluralities of square or rectangular joined subsections.

### DETAILED DESCRIPTION OF THE PREFERRED EMBODIMENTS

With reference to the appended illustrations, the present invention discloses a process for producing a multi-ply fiber sheet product for construction applications, and which incorporates many of the underlying features associated with forming conventional plywood, such as which is made of three or more thin layers of wood bonded together with an adhesive. In such known applications, each layer of wood, or ply, is usually oriented with its grain running at right angles to the adjacent layer in order to reduce the shrinkage and improve the strength of the finished piece. Most plywood is pressed into large, flat sheets used in building construction. Other plywood pieces may be formed into simple or compound curves for use in furniture, boats, and aircraft.

Known steps for forming the plywood sheets also includes assembling appropriate sections of veneer which are assembled for a particular run of plywood, at which point the process of laying up and gluing the pieces together begins. This may be done manually or semi-automatically with machines. In the simplest case of three-ply sheets, a back veneer is laid flat and is run through a glue spreader, which applies a layer of glue to the upper surface (such including any type of phenol-formaldehyde resin, soybean protein adhesive or urethane formaldehyde resin). Additional short sections of core veneer are then laid crossways on top of the glued back, and the whole sheet is run through the glue spreader a second time. Finally, the face veneer is laid on top of the glued core, and the sheet is stacked with other sheets waiting to go into the press.

At this point, the glued sheets are loaded into a multiple-opening hot press, such which can have the capacity of handling twenty to forty sheets at a time, such as with each sheet loaded in a separate slot. Upon all the sheets being loaded, the press squeezes them together under a given pressure, such including in one non-limiting example of about 110-200 psi (7.6-13.8 bar), while at the same time heating them to a desired elevated temperature (such can include a range of about 230-315° F. (109.9-157.2° C.). The pressure assures good contact between the layers of veneer, and the heat causes the glue to cure properly for maximum strength. After a period of time (in one example 2-7 minutes), the press is opened and the sheets are unloaded.

Additional forming steps associated with known plywood forming processes include passing the rough sheets through a set of saws, which trim them to their final width and length. Higher grade sheets can pass through a set of wide belt sanders, which sand both the face and back. The finished sheets are stamped with a grade-trademark that gives the buyer information about the exposure rating, grade, mill number, and other factors, with sheets of the same grade-trademark are strapped together in stacks and moved to the warehouse to await shipment.

Having provided above a basic description of a known prior art forming process for forming a plywood sheet article, an explanation will now be provided of a process for forming a ply-fiber sheet which utilizes a number of the same steps, albeit in a non-obvious fashion in order to produce a construction article which is based on any natural occurring waste or by-product not limited to any of bamboo fibers, sugar cane stalks, corn stalks, palms, coconuts and the like.

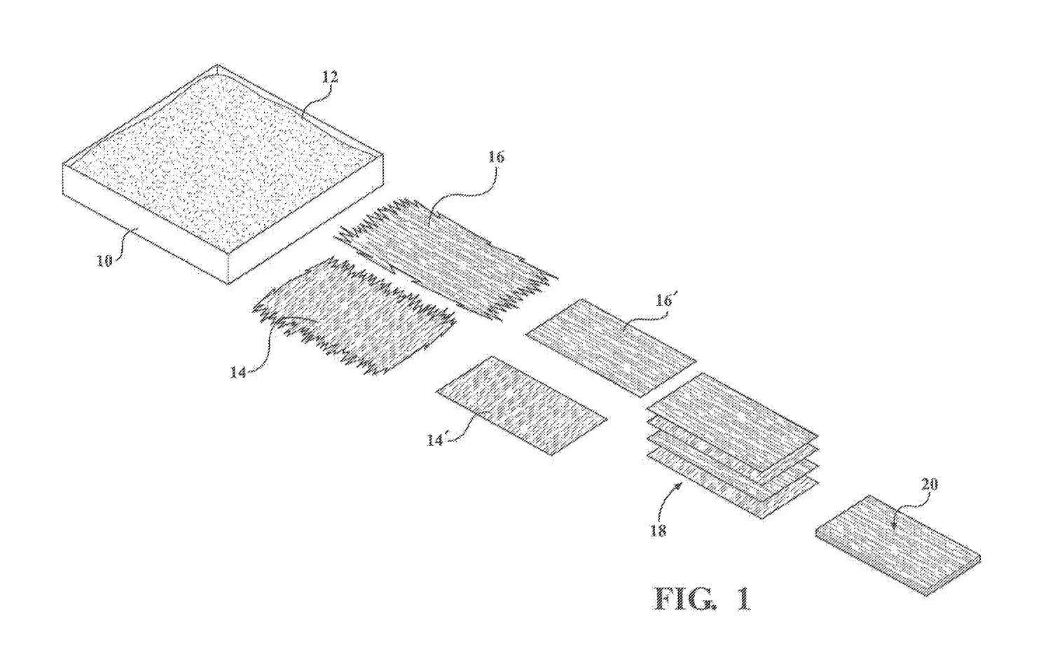

Referring initially to FIG. 1, an illustration is provided of a first variant of a line process for creating a multi-ply fiber sheet. This includes the provision of a non-activated adhesive fluid bath (see enclosure 10 filled with a water based adhesive solution 12), within which the previously prepared fiber sheets, shown at 14 and 16 and having previously being cleaned and treated for pests or moisture, are immersed for coating with the adhesive. The non-activated adhesive integrated into the water based solution 12 can, without limitation, include any combination of water, polymers, and additives, and are ideal for porous or non-porous substrates.

Such adhesives may be formulated as solutions or powders and are activated by a succeeding event, such as upon the water evaporating or being absorbed by the substrate as well as, will be further described, activated to cure by the combination of the application of heat and pressure (heat press, roller or like process). Such heat activated adhesives are tack-free (non-sticky) until heated. These products form very strong bonds and are typically used as structural adhesives.

The fiber mats shown at 14 and 16 each including crosswise extending grains or seam edges established between the individual jointed strips of material constituting the mat. As previously described, the mats can be produced from any fiber material not limited to any naturally occurring waste or bi-product and such further including any appropriate material not limited to bamboo strips, sugar cane stalks, corn stalks, palms, coconut or the like.

In comparison to the above scribed prior art process for forming plywood (such as which provide the successive steps of debarking the wood log, applying a cut off saw to loosen its outer perimeter, soaking the loak and, finally, peeling the wood into thin ye using a peeler lathe), the present process and assembly aggregates strips of the fibers which are then pre-formed into the mats 14/16 with the grains extending in crosswise fashion. Preforming can include utilizing a first type of adhesive to assist in forming the mats (this separate from the non-tacky heat activated water based adhesive supported within the immersion bath 12). Alternatively, the mats 14/16 can be formed in the bath 12 as part of an initial forming process.

As further shown in FIG. 1, the previously formed mats 14/16 (such having been pre immersed into the fluid bath or otherwise coated with the non-activated adhesive) are subsequently formed into the sheets, trimmed (see at 14′ and 16′), stacked (at general step 18 which includes stacking any plurality such as four shown of the sheets with alternating and crosswise extending grains), and placed into a heat press (not shown) in order to activate the adhesive in order to bond the sheets together. As previously described, the heat press can include any structure likewise associated with a conventional plywood forming process and which operates in order to bond together the pre-stacked plurality of formed and trimmed fiber layers, such depicted by finished product 20.

In either instance, the sheets are formed with an individual thickness measure in mils or 1/16″ of an inch or more and, upon be subsequently stacked in a given plurality f typically three to five sheets, results in an eventual thickness of commercially identified type including without limitation any of ⅜″, ½″, ¾″ or 1″ thickness. Typical planar dimensions, without limitation, can include 4′×8″ as is know with typical plywood.

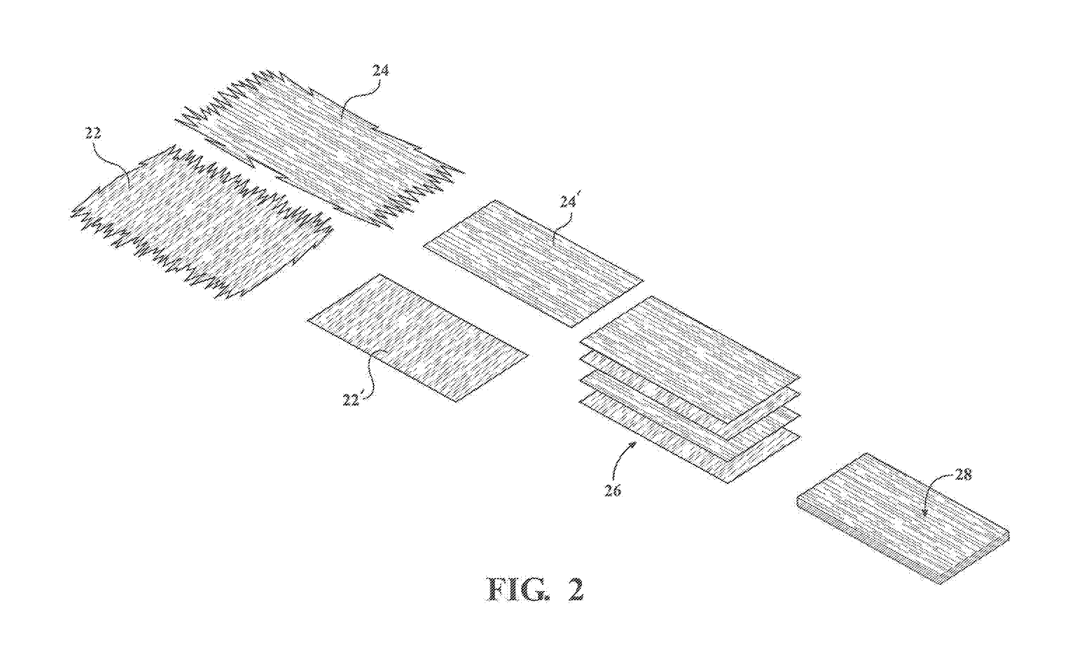

FIG. 2 is a similar illustration of a further forming process in which an array of fiber sheets, a pair of these further shown at 22 and 24, are arranged in respective oriented (lengthwise versus crosswise) and seam extending directions, such as prior to being post or cylinder rolled or pressed into thin sheets, at 22′ and 24′. The pressing action occurs concurrently and activates in each mat a previously coated liquid adhesive (this can optionally include but does not require the water activated immersion bath of FIG. 1 and can include other structures and processes for aggregating and pre-forming the individual mats in the manner shown), such via any of liquid, light, steam, heat or the like.

In at least this variant, the sheets of ply fiber mats are precut in a specified oversized dimension (such as to account for subsequent shrinkage) and subsequently stacked (see step 26 including any plurality such as four shown and without the necessity of pre-positioning or flipping the sheets beforehand). The stacked sheets are then glued (before, during or after stacking) and pressed together to form a thick solid finished sheet (further at 28) which is cut to size.

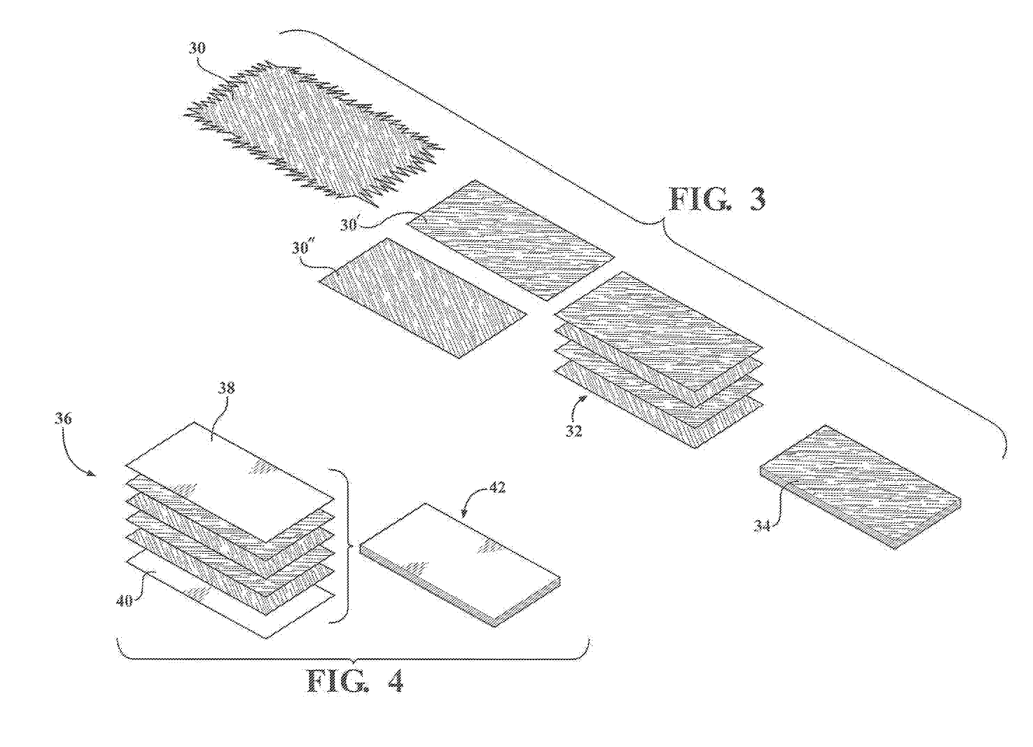

Proceeding to FIG. 3, a related further variant is depicted of a diagonal orientation of the seams associated with a plurality of ply-fiber formed sheets (see exemplary sheet 30), such eliminating the necessity of dual setups for lengthwise and widthwise fiber sheets and instead including the diagonal fiber sheets being produced in a single setup for laying in and forming the ply fiber mat 30. In this manner, alternating ones of the pre-trimmed sheets 30′ and 30″ are flipped to create a diagonally opposing grains between adjoining layers.

In this manner, one mid-length diagonal orientation is made in sheet 30′, with succeeding sheet 30″ made in similar fashion within the same setup and then rotated 180 degrees about its length dimension in order to create a counter extending seam pattern of the assembled strips forming the ply fiber layer. As further shown by the stacked plurality of sheets (four) depicting alternating diagonal seams or grains (at 32 and with the second and fourth of the sheets or mat layers having been flipped/rotated) the orientation provided is determined to provide superior stress bending support to those of standard crosswise extending seams, this owing to the generally longer length dimensions of the middle extending seams in combination with the orientation of the grains away from that load experiencing direction. The completed multi fiber-ply product is shown at 34 and can again include any overall dimensions or thickness appropriate with a given application as a structural wallboard, flooring or other article.

FIG. 4 is a stacked illustration, generally at 36 of multi-ply fiber sheets (again four shown as previously depicted at 32 in FIG. 3 and including alternating diagonal extending seams/grains). A pair of natural wood layers, at 38 and 40, are added as outer layers to the final produced product, see further at 42, in order to exhibit a natural exterior appearance.

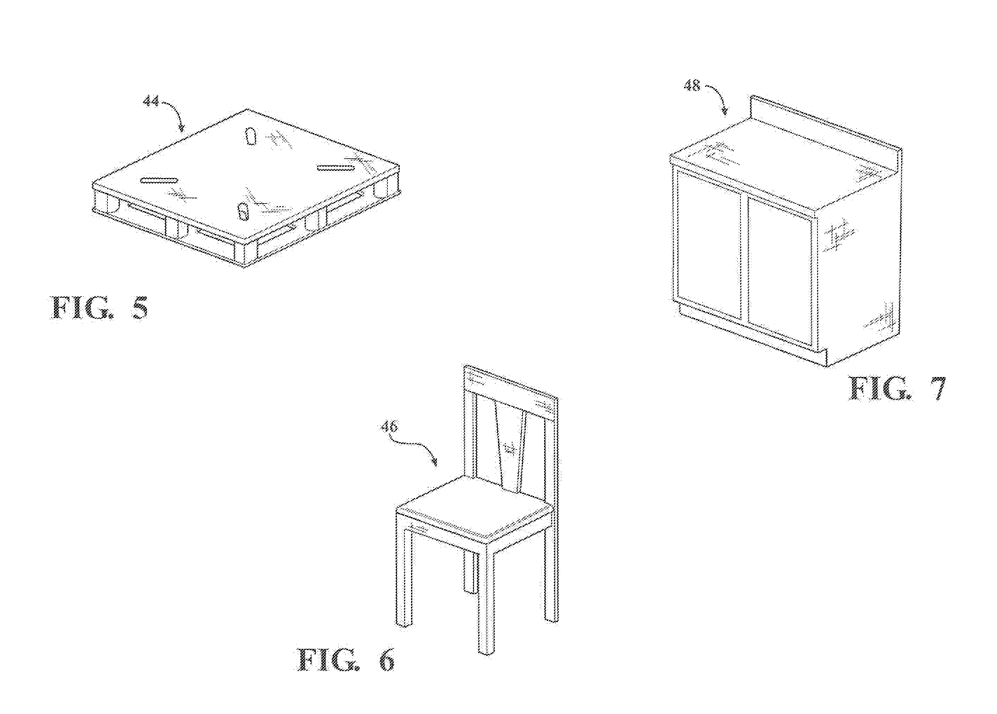

FIGS. 5-7 provide a illustrations of exemplary articles which are produced according to the process for forming a multi ply-fiber article, such including, by non-limiting examples, each of pallets 44 or other material handling and supporting articles (FIG. 5), furniture articles not limited to a chair 46 (FIG. 6) and cabinetry/building trades 58 (FIG. 7). To this end the forming processes identified in FIGS. 1-4 are capable of being modified to vary the dimensions of the ply-fiber structural articles being produced, these exhibiting upon completion the same overall properties of plywood.

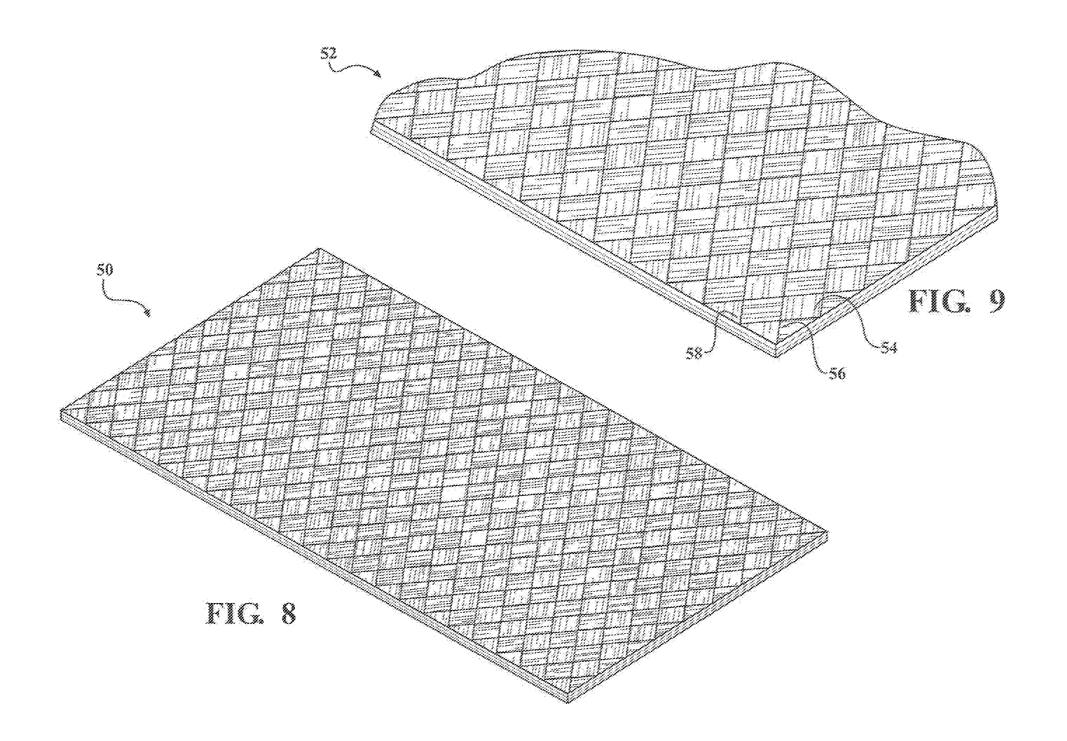

FIG. 8 is an illustration, generally at 50 of a structural panel produced according to a further embodiment of the present invention and which incorporates a plurality of overlapping layers (similar to as previously shown at 18) of any of compressed and thin sheet formed fibers not limited to any of bamboo leaves, burlap, palm, tree, fiber, banana leaves or the like and which are formed in a manner consistent with that previously described. As is further understood, the formed panel can include any number of individual plies or layers and can further incorporate either straight or woven fibers.

Finally, FIG. 9 is an illustration of an alternate version of structural panel, generally at 52, in which the individually joined sections of organic material including in the listing of FIG. 8 also include any of pluralities of square or rectangular joined subsections, see further at 54, 56, 58, et seq. Although not shown, the present invention contemplates provision of any combination of a first forming process for forming any plurality of sheets, plies or individual sections according to the previous detailed description, this in combination with any follow up process for forming the individual thickened sections (such as by compressing and binding the organic materials into the individual disks, wafers, squares or other shape) which are then bonded edge to edge in the manner shown prior to final sectioning and trimming operations.

The present invention further contemplates the use of any type of waterproof glue with foaming agent in the production of the individual sections 54, 56, 58 et seq. of material, and which can then be formed into thickened sheets according to any of the formation methods shown in any of the embodiments described. Additional variants include adding any desired surfacing material (such as a foam or carpet) to either or both sides of the structural sheet article created for any desired flooring application.

Having described my invention, other and additional preferred embodiments will become apparent to those skilled in the art to which it pertains, and without deviating from the scope of the appended claims.

I claim:

1. A line process for creating a multi-ply fiber sheet, comprising the steps of:
providing a non-activated adhesive fluid bath;
immersing within said fluid bath a series of ply fiber sheets in order to coat a heat activated adhesive;
stacking said sheets according to a desired plurality; and
activating the adhesive within the stack to bond said sheets together.

2. The process as described in claim 1, further comprising the step of pre cleaning and treating the said sheets prior to immersing.

3. The process as described in claim 1, further comprising the step of stacking individual ply fiber sheets in alternating lengthwise and crosswise seam extending fashion.

4. The process as described in claim 1, further comprising the step of stacking individual ply fiber sheets in alternating and opposing diagonal extending directions.

5. The process as described in claim 1, said step of activating the adhesive further comprising placing the stack into a heat press.

6. The process of claim 1, said step of activating the adhesive further comprising any of liquid, light, steam, or heat.

7. The process of claim 1, further comprising the step of precutting said sheets to a specified oversized dimension prior to subsequently stacking, gluing and pressing together to form a thick solid finished sheet which is cut to size.

8. The process of claim 4, further comprising the step of producing said sheets within a single setup and flipping alternate sheets to create diagonally opposing grains.

9. The process of claim 1, further comprising the step of applying natural wood layers around the stacked sheets.

10. The process of claim 1, further comprising the step of forming the ply fiber sheets from any of natural occurring or organic waste or byproduct integrating one or more components not limited to bamboo, sugar cane stalks, corn stalks, palms, or coconut.

11. The process of claim 1, further comprising the step of producing any of sheet, pallet, furniture or cabinetry articles.

12. The process of claim 1, further comprising the step of forming each sheet from a plurality of organic materials.

13. The process of claim 12, further comprising the step of selecting and bonding loose organic materials into the sheets, the materials including any of tree fibers, burlap, bamboo leaves, palm leaves, and banana leaves.

14. The process of claim 13, further comprising the step of applying a waterproof glue with a foaming agent in the formation of individual sub-sections of said organic material prior to said step of bonding together the sheets.
